(19) United States
(12) Patent Application Publication
(10) Pub. No.: US 2025/0215922 A1
(43) Pub. Date: Jul. 3, 2025

(54) FOIL BEARING AND BEARING BLOCK FOR RECEIVING A FOIL BEARING

(71) Applicant: ZF CV Systems Global GmbH, Bern (CH)

(72) Inventor: Janik Ricke, Uetze (DE)

(21) Appl. No.: 19/084,563

(22) Filed: Mar. 19, 2025

Related U.S. Application Data
(63) Continuation of application No. PCT/EP2023/073810, filed on Aug. 30, 2023.

(30) Foreign Application Priority Data
Sep. 20, 2022 (DE) 10 2022 124 129.7

(51) Int. Cl. F16C 17/02

(52) U.S. Cl. CPC F16C 17/024; F16C 2360/24

(57) ABSTRACT

A foil bearing has a bearing bushing with a central recess having a bearing surface for rotatably mounting a shaft, a rotatably mounted shaft extending along a longitudinal axis of the recess, and at least one bearing foil which is intended to be arranged in a gap between the bearing surface of the bearing bushing and a running surface of the shaft. The bearing bushing has on at least one side, in the region of its recess, and/or the shaft has at a shaft portion an insertion surface that extends obliquely with respect to the bearing surface on the recess and/or to the running surface on the shaft.

### CROSS-REFERENCE TO RELATED APPLICATIONS

This application is a continuation application of international patent application PCT/EP2023/073810, filed Aug. 30, 2023, designating the United States and claiming priority from German application 10 2022 124 129.7, filed Sep. 20, 2022, and the entire content of both applications is incorporated herein by reference.

### TECHNICAL FIELD

The disclosure relates to a foil bearing having a bearing bushing with a central recess, wherein the recess has a bearing surface for supporting a shaft such that it is rotatable about a longitudinal axis, and at least one bearing foil which is arranged in the recess and is adapted to form a gap between itself and a running surface of the shaft. Furthermore, the disclosure relates also to a bearing block for receiving a foil bearing, having a passage with a stepped diameter which is adapted to receive the bearing bushing and which has a portion for insertion of a shaft that is to be inserted into the bearing bushing.

### BACKGROUND

Such foil bearings are known in the prior art and are commonly used for the bearing of rapidly rotating shafts. Such foil bearings, which are also referred to as fluid dynamic bearings, have the property that, when the shaft is stationary and at relatively low rotational speeds, the shaft rotating in the bearing bushing is in contact in at least one contact region with the bearing foil arranged between the bearing surface of the bearing bushing and the running surface of the shaft. Friction thus occurs between the shaft and the bearing foil when the shaft rotates. The bearing foils can additionally be used to hold the shaft with its running surface spaced apart from the bearing surface of the bearing bushing, in order to minimize the friction that occurs.

As the rotational speed increases, pressure builds up between the shaft and the bearing foil in contact with the running surface of the shaft and presses the bearing foil against the bearing surface of the bearing bushing. Above a lift-off rotational speed of the shaft, a hydrodynamic force develops in the contact region between the bearing foil and the shaft and causes the shaft to be lifted from the inner side of the bearing foil. In the case of foil bearings, the lubrication wedge that forms is filled with gas, commonly with air, as “lubricant”.

In order to ensure that a lubrication gap is produced between the bearing foil and the shaft, such foil bearings require a high dimensional accuracy of the components that are to be joined together. On assembly of such foil bearings, in particular on insertion of a shaft into the recess of the bearing bushing, the recess being adapted exactly to the outside diameter of the shaft, canting of the shaft in the recess can occur at the start of the insertion movement, which makes assembly more difficult or even results in damage to the surfaces. Especially when the bearings are to be assembled and installed not by hand but by machine, correct assembly is to be ensured for subsequent failure-free operation of such a foil bearing.

### SUMMARY

It is an object of the disclosure to provide a foil bearing, a bearing block for receiving a bearing bushing, and a bearing arrangement, via which the assembly of such a foil bearing is facilitated and damage to a foil bearing assembled in particular by machine is avoided.

The disclosure achieves the underlying object in accordance with a first aspect by a foil bearing including: a bearing bushing having a central recess, wherein the central recess has a bearing surface for mounting a shaft such that the shaft is rotatable about a longitudinal axis; at least one bearing foil arranged in the central recess and adapted to form a gap between the at least one bearing foil and a running surface of the shaft; and, wherein at least one of: the bearing bushing has, on at least one side of the bearing bushing in a region of the central recess, an insertion surface extending obliquely with respect to the longitudinal axis, and, the bearing bushing is configured to receive a shaft portion of the shaft that has a shaft insertion surface extending obliquely with respect to the longitudinal axis.

In particular, various embodiments of the disclosure is distinguished in that the bearing bushing has on at least one side, in the region of its recess, an insertion surface that extends obliquely with respect to the longitudinal axis, and/or is adapted to receive a shaft portion of the shaft that has an insertion surface that extends obliquely with respect to the longitudinal axis.

The disclosure is based on the finding that there is to be provided or formed on at least one component of the foil bearing, that is, on the bearing bushing or the shaft or on the bearing bushing and the shaft, an insertion surface that extends obliquely and via which assembly, especially the bringing together of the bearing bushing and the shaft, is facilitated. In particular, the insertion surface on the bearing bushing and/or the shaft is intended to counteract canting of the running surface of the shaft with the inner side of the bearing foil arranged on the bearing surface of the bearing bushing when the shaft is being inserted into the recess of the bearing bushing. The insertion surface on the bearing bushing is preferably formed on one side in an end region of the recess. Via the oblique extent of the insertion surface, wherein “oblique” is here understood to mean not extending parallel to the longitudinal axis, a guide portion for the shaft is provided, with which it is at the same time possible to compensate for a radial offset of the longitudinal axes of the shaft and the recess of the bearing bushing. The insertion surface on a shaft that is to be inserted into a recess is preferably formed at an end of the shaft portion that axially delimits the running surface of the shaft. In one possible embodiment of the foil bearing, an insertion surface is provided both at least at one end portion of the recess of the bearing bushing and at one end of a shaft portion of the shaft, wherein the insertion surfaces on the bearing bushing and on the shaft slide against one another without canting on insertion of the shaft into the recess of the bearing bushing. An “obliquely” extending insertion surface on the shaft is to be understood as meaning that the insertion surface does not extend parallel to the longitudinal axis about which in particular the shaft rotates.

According to various embodiments of the disclosure, it is provided that at least one insertion surface is formed in each case on both sides of the bearing bushing and/or along two shaft portions of the shaft that are arranged at a distance from one another. As a result of the configuration of the insertion surfaces on both sides of the bearing bushing and/or the shaft, assembly is facilitated inasmuch as a shaft can be inserted with each of its ends into the corresponding recess of a bearing bushing of the foil bearing. Owing to the configuration of insertion surfaces on both sides of the bearing bushing, the shaft can be inserted preferably from both sides into the recess that is formed in the bearing bushing and receives the shaft.

In the case of the configuration of an insertion surface on both sides of the bearing bushing, the insertion surfaces are in each case formed on the bearing bushing in the end regions of the recess that receives the shaft. In the case of the configuration of insertion surfaces on both sides of the shaft, the shaft has the insertion surfaces preferably at both ends of its running surface corresponding with the recess. Simply as a result of the provision of an insertion surface on one side of the bearing bushing and/or of the shaft, the bearing bushing and/or the shaft in each case has a shortened configuration of the bearing surface and/or running surface. In the case of the configuration of insertion surfaces on both sides of the bearing bushing and/or of the shaft, the insertion surfaces in each case extend obliquely with mutually opposite angles.

In various embodiments, the insertion surface is configured as a circumferential chamfer and extends between an end face of the bearing bushing or shaft and the bearing surface on the bearing bushing or the running surface on the shaft. The provision of a chamfer effects a structurally simple possibility for configuring an insertion surface that extends obliquely. Such a chamfer, which in itself extends flat in the direction of extent, can be produced both on the bearing bushing and on the shaft in a relatively simple manner via a machining process. With the chamfer formed circumferentially on at least one side of the bearing bushing and/or shaft, in particular a wedge-shaped insertion portion is produced.

Preferably, the insertion surface, based on the longitudinal axis of the bearing bushing, extends obliquely at an angle α of less than 45°, preferably approximately 30°. With a preferably acute angle between the insertion surface and the longitudinal axis of the bearing bushing and/or of the shaft having the insertion surface, assembly of the foil bearing according to the disclosure is further facilitated. The cone angle of approximately 60° of the insertion surface that is provided in a preferred embodiment assists with the insertion of the shaft into the recess of the bearing bushing without canting.

In various embodiments of the foil bearing according to the disclosure, the insertion surface is convexly curved. Instead of a chamfer that extends flat in the direction of extent, the insertion surface, which is likewise formed circumferentially at a respective end region of the recess in the bearing bushing or of the running surface of the shaft, can be configured similarly to a rounded edge. The convexly curved insertion surface is to be understood as being a bulge in the direction of the surface normal to the insertion surface. In other words, a rounding of a body edge between the bearing surface or running surface and the end face of the bearing bushing or the rotor, for example, is to be understood as being a convex insertion surface.

With the convex configuration of the insertion surface, a shoulder-free transition from the insertion surface to the bearing surface of the bearing bushing or the running surface of the shaft can be produced, whereby cant-free insertion of the shaft into the recess in the bearing bushing is further assisted. The convexly curved insertion surface preferably extends obliquely in the direction of extent with a changing gradient. A preferred embodiment provides that, as the distance from the end face of the bearing bushing and/or shaft increases, the gradient at the insertion surface decreases. In a preferred embodiment, it is sufficient for the convexly curved insertion surface to have an edge in the transition to the bearing or running surface, whereby the axial length of the insertion surface is reduced.

Preferably, with the provision of insertion surfaces on the bearing bushing and on the shaft, the length thereof in the direction of the longitudinal axis can be reduced to half the length of an insertion surface that is otherwise formed on only one component of the foil bearing according to the disclosure. It is thus possible to compensate for the same radial offset, wherein the width of the bearing surface of the bearing bushing and of the running surface of the shaft is increased while the overall length remains the same.

According to various embodiments of the foil bearing according to the disclosure, it is provided that the bearing foil has a width dimension that corresponds to the width of the bearing surface of the bearing bushing. The bearing foil arranged on the inner side of the recess terminates with its side edges directly flush with the respective ends of the running surfaces of the bearing bushing. In particular with the configuration of an insertion surface along a shaft portion of the shaft, in particular at one end of the running surface, a shoulder in the transition from the insertion surface on the bearing bushing to the running surface, produced by the radially projecting bearing foil, for the shaft moving along the running surface can be compensated for in a simple manner.

In various embodiments of the foil bearing according to the disclosure, the bearing foil has a width dimension that is shortened compared to the width dimension of the bearing surface of the bearing bushing. Thus, immediately at the transition from the insertion surface to the bearing surface of the bearing bushing, an inwardly projecting shoulder as a result of the side edge of the bearing foil in contact with the running surface of the bearing bushing and an associated sudden reduction in the free diameter of the recess is avoided. Especially on insertion of a shaft end along the insertion surface, the striking of an end face of the shaft that is to be pushed into the recess is avoided, whereby the insertion of a shaft into the bearing bushing is further facilitated. Preferably, the side edge of the bearing foil is at a distance of approximately from 0.5 to 2 mm from the end of the bearing surface formed on the bearing bushing. The shortened configuration of the bearing foil relative to the bearing surface of the bearing bushing is provided at least on the side of the bearing bushing that is intended for insertion of the shaft.

According to various embodiments, the bearing foil is shortened relative to the bearing surface, at least at one face of the bearing bushing, such that a side edge defining the width dimension of the bearing foil is in alignment with the oblique extent of the insertion surface. With the arrangement of the side edge of the bearing surface in alignment with the insertion surface, insertion of the shaft into the bearing bushing is further facilitated. A side edge of the bearing foil arranged in such a manner at a distance from the end of the bearing surface on the bearing bushing forms a type of wedge that lengthens the insertion surface. Preferably, the distance of the side edge of the bearing foil from the respective associated end of the bearing surface of the bearing bushing varies in dependence on the chosen angle α of the insertion surface or the angle of the changing gradient of the insertion surface at the transition to the bearing surface.

Preferably, a plurality of bearing foils are arranged one above the other in the gap between the bearing surface of the bearing bushing and the running surface of the shaft. With the provision of a plurality of bearing foils within the gap between the bearing bushing and the shaft, different functions can preferably be performed by the various bearing foils. The bearing foil arranged on the outside is preferably configured as a spring foil. This exerts a spring force in the radial direction on the running surface of the shaft, in particular over the entire circumference, so that the shaft is held in the recess at as uniform a distance as possible from the bearing surface of the bearing bushing. Via a further running foil arranged between the spring foil and the running surface of the shaft, friction between the running foil and the bearing foil when the shaft starts up is preferably kept as low as possible.

Preferably, when two or more foils are used at least on the side provided for insertion of the shaft into the bearing bushing, the side edges of all the bearing foils are configured so as to be shortened relative to the respective associated end of the bearing surface of the bearing bushing. Preferably, the bearing foil that is in direct contact with the bearing surface of the bearing bushing is shortened on at least one side by from 0.5 to 2 mm relative to the width of the bearing surface of the bearing bushing. A further bearing foil configured, for example, as a running foil is shortened on the corresponding side of the bearing bushing by from 0.5 to 2 mm relative to the width of the bearing foil. The side edges of a plurality of bearing foils are thus stepped relative to one another.

In various embodiments of the foil bearing, the bearing foil arranged on the inside has an internal width dimension B_{Mi} that is shortened compared to an external width dimension B_{Ma} of the bearing foil arranged on the outside, wherein preferably the side edges of both bearing foils and at least one end region of the bearing bushing are arranged in alignment with the insertion surface. With such an arrangement according to the disclosure of the side edges of the bearing surfaces, an insertion region for the shaft to be received in the bearing bushing that lengthens the insertion surface is produced. The side edges of a plurality of bearing foils form in particular a wedge adapted to the angle of the insertion surface, for facilitated pushing of the shaft into the recess of the bearing bushing. Especially the insertion of a rotor shaft into the bearing bushing by machine is possible without jamming during the insertion operation.

Various embodiments of the foil bearing according to the disclosure provide that an axially protruding locking element is arranged on an end face of the bearing bushing. Via a directly visible locking element, the end of the bearing bushing that is intended for insertion of the shaft is marked. It is thus avoided that a bearing bushing provided for receiving a shaft is inserted with the wrong end into, for example, a bearing block on a housing. Both for assembly by hand and for the insertion of a shaft into the bearing bushing by machine, the insertion of a shaft into a bearing bushing intended therefor is further facilitated by the provision of a locking element, which is preferably configured as a securing pin. In addition, with the locking element protruding from an end face of the bearing bushing, locking of the bearing bushing in the bearing block in the direction of rotation of the shaft is effected. Corotation of the bearing bushing when the shaft guided in the bearing bushing is being driven is thus counteracted.

A further aspect of the present disclosure relates to a bearing block for receiving a foil bearing, in particular a foil bearing, having a passage with a stepped diameter which is adapted to receive the bearing bushing and which has a portion for insertion of a shaft that is to be inserted into the bearing bushing. A bearing block is to be understood, for example, as being part of a housing that accommodates the bearing bushing. A bearing block is thus not necessarily a component that is formed separately to other components of an apparatus that accommodates the bearing block. The bearing block can, however, also be a component part that is formed separately on an apparatus or a device. In addition, the bearing bushing can be a permanent component part of the bearing block, so that the bearing block itself is part of the foil bearing according to the disclosure. The bearing block then preferably has at least one insertion surface at its passage, into which the rotor/shaft is inserted.

The bearing block according to the disclosure achieves the object on which the foil bearing was based in that the portion of the passage that is intended for insertion of the shaft is adapted in terms of its diameter to the insertion surface on the bearing bushing received in the bearing block. A passage formed in the bearing block for receiving the shaft thus has a portion with a diameter that is at least as large as the largest dimension of the insertion surface formed at one end of the bearing bushing that is to be inserted into the bearing block. In particular, the diameter of the passage in the bearing block through which the shaft is to be guided is chosen in dependence on the length of the passage. The longer this portion of the bearing block, preferably the larger the diameter of the portion arranged adjacent to the recess in the bearing bushing and through which the shaft is to be guided.

A development of the bearing block according to the disclosure provides that there is provided in the passage a recess that extends in the axial direction and can be brought into operative connection with the locking element of the bearing bushing. The recess in the interior of the passage provides a possible way of producing a positive connection that secures the bearing bushing in the direction of rotation of the shaft. The recess is formed in particular on a wall surface of the bearing block that extends in the radial direction and that is configured in particular as a contact surface for the bearing bushing to be inserted in the axial direction into the bearing block.

Preferably, there is formed on the bearing block, for axially securing the bearing bushing within the passage, a depression, extending in the circumferential direction, for a securing element, in particular an inner securing ring, corresponding thereto. With the provision of a depression on the lateral surface of the passage, which in particular is of cylindrical form, the bearing bushing is prevented from moving axially out of the bearing block during operation of an apparatus configured with such a bearing bushing. The securing element, which may be an inner securing ring, engages into the circumferential groove formed in the lateral surface of the passage. Such an inner securing ring is mounted in particular after the bearing bushing has been inserted in the passage in the bearing block. The securing ring preferably cooperates in a positive manner with the depression in the passage of the bearing block.

In a further aspect, the disclosure relates to a bearing arrangement having a foil bearing, and a shaft mounted in the foil bearing such that it is rotatable about a longitudinal axis, wherein the foil bearing has a bearing bushing with a central recess, wherein the recess has a bearing surface for mounting the shaft such that it is rotatable about the longitudinal axis, and at least one bearing foil which is arranged in the recess and is adapted to form a gap between itself and a running surface of the shaft, wherein the bearing bushing has on at least one side, in the region of its recess, an insertion surface that extends obliquely with respect to the longitudinal axis, and/or the shaft has a shaft portion arranged within the bearing bushing that has an insertion surface that extends obliquely with respect to the longitudinal axis.

### BRIEF DESCRIPTION OF DRAWINGS

The invention will now be described with reference to the drawings wherein:

FIG. 1 shows a view of a rotor-stator assembly as an application example for a foil bearing according to the disclosure;

FIG. 2 shows a view of a first embodiment of a foil bearing according to the disclosure in accordance with FIG. 1, in section;

FIG. 3 shows a view of a second embodiment of a foil bearing according to the disclosure;

FIG. 4 shows a further view of an embodiment of a foil bearing according to the disclosure;

FIG. 5 shows a view of a fourth embodiment of a foil bearing according to the disclosure, in section; and,

FIG. 6 shows a view of a further bearing arrangement according to the disclosure before insertion of a foil bearing into a bearing block.

### DETAILED DESCRIPTION

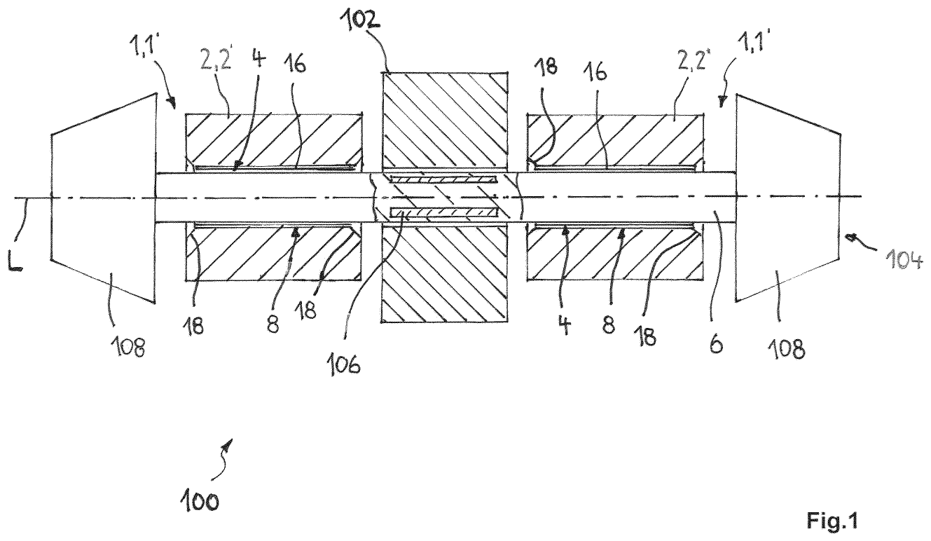

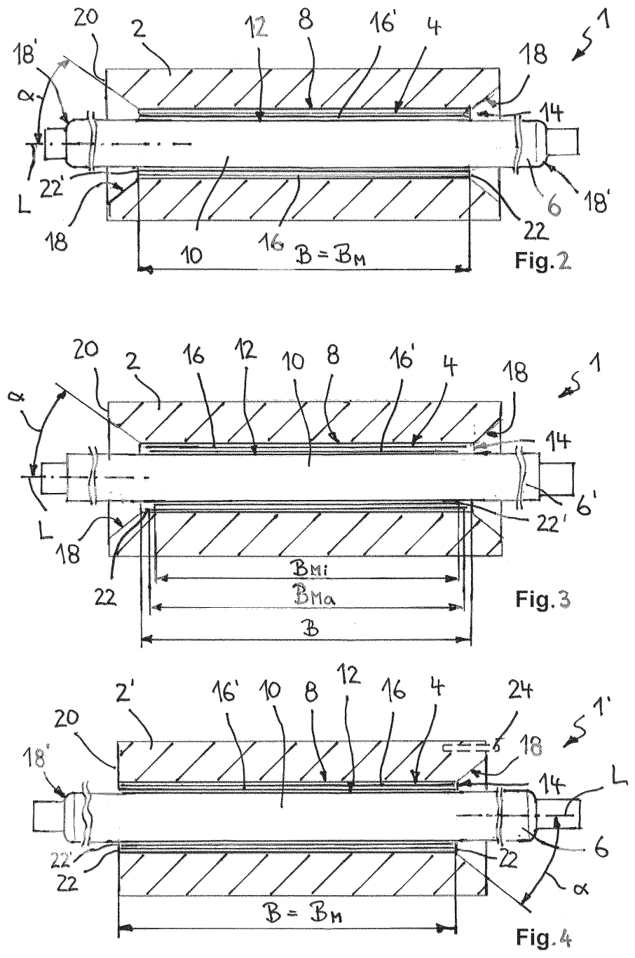

FIG. 1 shows a rotor-stator arrangement 100 as a possible application example for a foil bearing 1 according to the disclosure (FIGS. 2 to 5). The rotor-stator arrangement 100 comprises a stator 102 and a rotor 104 which is held in such a manner that it is rotatable relative to the stator 102. The rotor 104 comprises a shaft 6 which extends through the stator and within which there is arranged at least one magnet 106 which cooperates with the stator 102. The rotor-stator arrangement 100 here forms an electric machine for generating a rotational movement of the rotor 104.

On both sides of the stator 102, the rotor 104 is mounted via foil bearings 1, 1′. The foil bearings 1 are configured as radial bearings and form a two-part, or split, foil bearing for the rotor 104. The foil bearings 1 additionally have at least one bearing foil 16 for mounting the rotor 104 in particular in the radial direction with respect to its longitudinal axis L.

At least at one end of the shaft 6 of the rotor 102 there is arranged a compressor wheel 108, which is set in rotational motion via the rotor-stator arrangement 100. In the embodiment shown here, a compressor wheel 108 is arranged at each end of the shaft 6 of the rotor 104. Preferably, the rotor-stator arrangement 100 shown here forms a two-stage compressor, or a compressor-expander arrangement.

The rotor-stator arrangement 100 preferably further has at least one axial air bearing (not shown in detail), for example a foil bearing or a spiral groove bearing. Via the axial air bearing, the rotor 104 in the axial position relative to the stator 102 of the arrangement 100 is supported in a contactless manner against axial forces.

FIG. 2 shows a foil bearing 1 of the rotor-stator arrangement 100 of FIG. 1, which has a bearing bushing 2 with a central recess 4, and a rotatably mounted shaft 6 extending along a longitudinal axis L of the recess 4. The bearing bushing 2 has a bearing surface 8 which defines the recess 4 in the bearing bushing 2.

The shaft 6 has a shaft portion 10 which is received in the recess 4 of the bearing bushing 2 and which has a running surface 12. Between the bearing surface 8 of the bearing bushing 2 and the running surface 12 of the shaft 6 there is formed a gap 14, in which at least one bearing foil 16, 16′ is arranged. In the embodiment shown in FIG. 1, in particular two bearing foils 16, 16′ are arranged in the gap 14 between the shaft 6 and the bearing bushing 2.

In order to facilitate in particular the insertion of the shaft 6 with its shaft portion 10 into the recess 4 of the bearing bushing 12, in the present embodiment at least the bearing bushing 2 has at both ends an insertion surface 18 that extends obliquely with respect to the bearing surface 8 on the recess 4. “Oblique” is here to be understood as meaning not parallel to the longitudinal axis L.

In one possible embodiment, the shaft 6 optionally has along its shaft portion 10 at least one insertion surface 18′ that extends obliquely with respect to the running surface 12 on the shaft 6. In the embodiment shown in FIG. 2, insertion surfaces are provided at each end of the running surface 12 of the shaft 6. As a result, both the shaft 6 and the bearing bushing 2 can be brought into operative connection from both sides with the respective other component of the foil bearing 1.

In the embodiment shown in FIG. 2, in particular two bearing foils 16, 16′ are arranged in the gap 14 between the shaft 6 and the bearing bushing 2. In the present embodiment, both bearing foils 16, 16′ preferably have an internal width dimension B_{Mi} or an external width dimension B_{Ma} which in each case correspond to the width B of the bearing surface 8 of the bearing bushing 2.

The insertion surface 18′ on the shaft 6 is in particular convexly curved. Thus, in this embodiment, approximately equal widths of the bearing foils 16, 16′ and of the bearing surface 8 of the recess 4 can be counteracted. On insertion of the shaft 6 into the recess 4 of the bearing bushing 2, the shaft end, as a result of the curve at the insertion surface 18′ of the shaft 6, is able to slide easily against the shoulder produced by the side edges 22, 22′ of the bearing foils 16, 16′.

FIG. 3 shows a further embodiment of a foil bearing 1 according to the disclosure, which comprises a bearing bushing 2 formed identically to that in FIG. 2. The insertion surfaces 18 on the bearing bushing 2 are configured as circumferential chamfers and extend between the bearing surface 8 and an end face 20 defining in each case the end of the bearing bushing 2.

Based on the longitudinal axis L of the bearing bushing 2, the insertion surfaces 18 extend obliquely at an angle α of less than 45°, preferably approximately 30°.

The bearing foils 16, 16′ in the gap 14 between the shaft 6′ shown in FIG. 3 and the bearing bushing 2 have an internal width dimension B_{Mi} or an external width dimension B_{Ma} which are in each case reduced compared to the width B of the bearing surface 8 on the bearing bushing 2. Preferably, the inner bearing foil 16′ in contact with the running surface 12 of the shaft 6′ has an internal width dimension B_{Mi} which is reduced again relative to the external width dimension B_{Ma} of the outer bearing foil 16 in contact with the bearing surface 8 of the bearing bushing 2.

The bearing foils 16, 16′, to a certain extent as a reference dimension, with their width dimensions B_{Mi}, B_{Ma} are adapted to the width B of the bearing surface 8 and the angle α of the insertion surface 18, based on the longitudinal axis L, such that the bearing foils 16, 16′, with their side edges 22 in each case defining the width dimension B_{Mi}, B_{Ma}, are in alignment with the oblique extent of the insertion surface 18 on the bearing bushing 2.

Preferably, the bearing foils 16, 16′ of shortened form with their side edges 22, 22′ form a wedge that lengthens the extent of the insertion surfaces 18 on the bearing bushing 2. It is thus possible to dispense with the configuration of an insertion surface 18′, as shown in FIG. 2, on the shaft 6′ received in the bearing bushing 2.

Instead of the two bearing foils 16, 16′ arranged in the gap 14 between the shaft 6 and the bearing bushing 2, in other preferred embodiments there is arranged only one bearing foil 16. The single bearing foil 16 can have a width dimension B_{M} that corresponds to the width B of the bearing surface 8 of the bearing bushing 2 or, in an alternative embodiment, is also of shortened form relative to the bearing surface 8 on the bearing bushing 2.

FIG. 4 shows a possible third embodiment of a foil bearing 1′ having a bearing bushing 2′ which, instead of having an insertion surface at both ends of the bearing bushing, has such an insertion surface 18 only on one side of the bearing bushing 2. On the opposite side there is provided a conventional configuration of the bearing bushing 2 with a bearing surface 8 directly adjoining the end face 20. With the one-sided configuration of the insertion surface 18, the insertion region for the shaft 6 received therein is fixedly defined.

As in FIG. 2, the two bearing foils 16, 16′ have a width dimension B_{Mi}, B_{Ma} that corresponds in each case to the width B of the bearing surface 8. Instead of the two bearing foils shown, it is also possible for only one bearing foil or more than two bearing foils to be arranged in the gap 14.

The insertion surface 18 formed on only one side of the bearing bushing 2′ is again configured as a circumferential chamfer which extends at an angle of preferably 30° relative to the longitudinal axis L of the bearing bushing 2′. The insertion surface 18 on the bearing bushing 2′ extends flat in axial cross section in its direction of extent, that is, has a constant chamfer angle. The shaft 6 received in the bearing bushing 2′ has at least at one end, in particular at both ends, of the shaft portion 10 an insertion surface 18′ having a chamfer surface that is convexly curved in axial cross section.

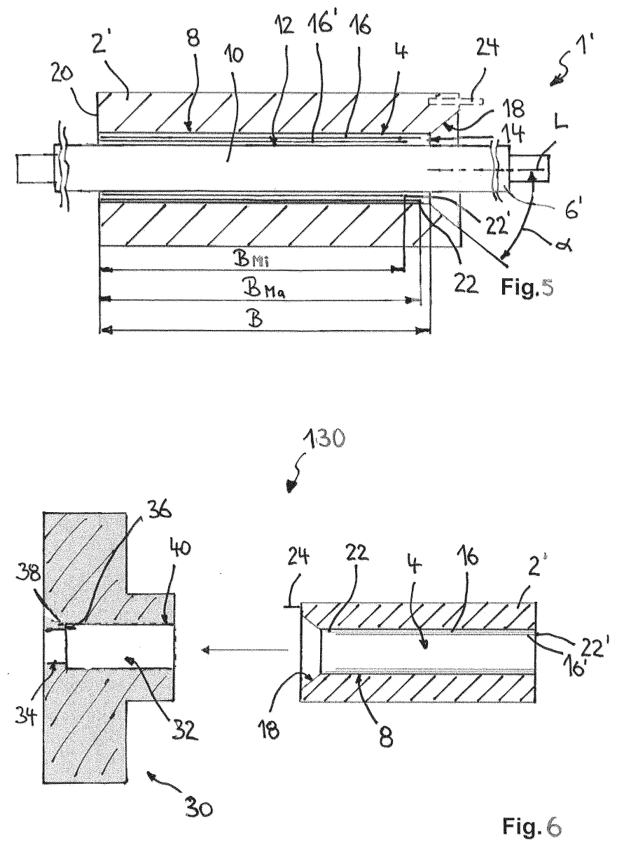

On the end face 20 provided with the insertion surface 18 there is arranged a locking element 24 that protrudes axially from the end face 20 of the bearing bushing 2. The locking element 24, here a cylindrical pin, serves to lock the bearing bushing 2′ in a bearing block 30, FIG. 6, that receives the bearing bushing 2′, whereby joint movement of the bearing bushing 2′ with the shaft 6 set in rotational motion within the bearing bushing is avoided.

FIG. 5 shows a further embodiment of a foil bearing 1′, which has a bearing bushing 2′ and a shaft 6′. In the gap 14 between the bearing bushing 2′ and the shaft 6′ there are arranged bearing foils 16, 16′, as in the embodiment shown in FIG. 3. The bearing foils 16, 16′ are of shortened form, based on the bearing surface 8 delimited by the insertion surface 18, at least on the side of the bearing bushing 2′ that is configured as a one-sided insertion region. The bearing foil 16 arranged on the outside is shortened relative to the width B of the bearing surface 8 of the bearing bushing 2′, and the bearing foil 16′ arranged on the inside is in turn shortened compared to the bearing foil 16. The side edges 22, 22′ of the bearing foils 16, 16′ have a stepped configuration.

Preferably, the bearing foils 16, 16′ have a width dimension B_{M} such that the side edges 22, 22′ at the end of the bearing bushing 2′ that is opposite the insertion region are in alignment with the end face 20 and the side edges 22, 22′ in the insertion region for the shaft 6′ are in alignment with the oblique extent of the insertion surface 18 formed on the bearing bushing 2′.

In the insertion region for the shaft 6′, the insertion surface 18 and the side edges, arranged offset relative to one another, of the bearing foils 16, 16′ arranged one above the other form a wedge for facilitated insertion of the shaft 6′ into the recess 4 in the bearing bushing 2′. The shaft 6′ received in the bearing bushing 2′ does not require an insertion surface 18′.

FIG. 6 shows a further bearing arrangement 130 according to the disclosure having at least one bearing block 30 for receiving a foil bearing 1, 1′ shown in the embodiments according to FIG. 2 to FIG. 5 and consisting of a bearing bushing 2, 2′ and a shaft 6, 6′ rotatably mounted in the bearing bushing.

The bearing block 30 has a passage 32 with a stepped diameter, within which the bearing bushing 2, 2′ can be arranged. The bearing block 30 is further adapted for the passage of a shaft 6, 6′ which is to be inserted into the bearing bushing 2, 2′. The bearing block 30 has at the passage 32 a portion 34 through which the shaft 6, 6′ is to be guided and which is adapted in terms of its diameter to the dimensions of the insertion surface 18 formed on the bearing bushing 2.

In the passage 32, in particular at the wall surface 36 extending in the radial direction, there is provided a recess 38 which extends in the axial direction and can be brought into operative connection with the locking element 24 arranged on the bearing bushing 2′. On insertion of the bearing bushing 2′ into the passage 32 in the bearing block 30, the locking element 24 is pushed into the recess 38 and forms a positive connection with the recess. This counteracts corotation of the bearing bushing 2, 2′ together with a shaft 6, 6′ received in the bearing bushing and set in rotational motion.

In one possible embodiment of the bearing arrangement 130, the bearing block 30 has a depression 40 which extends in the circumferential direction and which is adapted to receive a securing element (not shown in detail), whereby the bearing bushing 2′ is secured within the passage 32 in the axial direction.

The insertion surfaces 18, 18′ on the bearing bushing 2, 2′ and the shaft 6, 6′ are shown disproportionately large compared to the other parts/regions of the bearing bushing and the shaft in order better to illustrate the actual concept of the disclosure.

As is apparent in particular from FIG. 6, the bearing block 30 is shown on a reduced scale compared to the bearing bushing 2′ which is to be received within the passage 32 in the bearing block 30.

Identical or similar components are designated with the same reference numerals.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1, 1′ foil bearing
2,2′ bearing bushing
4 recess
6,6′ shaft
8 bearing surface
10 shaft portion
12 running surface
14 gap
16 outer bearing foil
16′ inner bearing foil
18, 18′ insertion surface
20 end face
22, 22′ side edge
24 locking element
30 bearing block
32 passage
34 portion
36 wall surface
38 recess
40 depression
100 rotor-stator arrangement
102 stator
104 rotor
106 magnet
108 compressor wheel
130 bearing arrangement
B width of bearing surface
B_{M} width dimension of bearing foil
B_{Mi} internal width dimension
B_{Ma} external width dimension
L longitudinal axis
α angle

1. A foil bearing comprising:
a bearing bushing having a central recess, wherein said central recess has a bearing surface for mounting a shaft such that the shaft is rotatable about a longitudinal axis;
at least one bearing foil arranged in said central recess and adapted to form a gap between said at least one bearing foil and a running surface of the shaft; and,
wherein at least one of:
said bearing bushing has, on at least one side of said bearing bushing in a region of said central recess, an insertion surface extending obliquely with respect to the longitudinal axis, and,
said bearing bushing is configured to receive a shaft portion of the shaft that has a shaft insertion surface extending obliquely with respect to the longitudinal axis.

2. The foil bearing of claim 1, wherein at least one of said insertion surface and said shaft insertion surface is formed at least at one of: on both sides of said bearing bushing, and along two shaft portions of the shaft that are arranged at a mutual distance.

3. The foil bearing of claim 1, wherein at least one of said insertion surface and said shaft insertion surface is configured as a circumferential chamfer and extends between an end face of said bearing bushing or shaft and said bearing surface on said bearing bushing or the running surface on the shaft.

4. The foil bearing of claim 1, wherein at least one of said insertion surface and said shaft insertion surface, based on the longitudinal axis of said bearing bushing or shaft, extends obliquely at an angle α of less than 45°.

5. The foil bearing of claim 1, wherein at least one of said insertion surface and said shaft insertion surface, based on the longitudinal axis of said bearing bushing or shaft, extends obliquely at an angle α of 30°.

6. The foil bearing of claim 1, wherein at least one of said insertion surface and said shaft insertion surface is convexly curved.

7. The foil bearing of claim 1, wherein said at least one bearing foil has a width dimension corresponding to a width of said bearing surface of said bearing bushing.

8. The foil bearing of claim 1, wherein said at least one bearing foil has a width dimension that is shortened compared to a width of said bearing surface of said bearing bushing.

9. The foil bearing of claim 1, wherein said at least one bearing foil is shortened relative to said bearing surface, at least at one face of said bearing bushing, such that a side edge defining a width dimension of said at least one bearing foil is in alignment with an oblique extent of said insertion surface.

10. The foil bearing of claim 1, wherein a plurality of said at least one bearing foil are arranged one above an other in said gap between said bearing surface of said bearing bushing and said running surface of said shaft.

11. The foil bearing of claim 10, wherein said plurality of said at least one bearing foil includes an inner bearing foil arranged on an inside and an outer bearing foil arranged on an outside; and, said inner bearing foil has an internal width dimension that is shortened compared to an external width dimension of said outer bearing foil.

12. The foil bearing of claim 11, wherein said inner bearing foil and said outer bearing foil each have side edges that are in alignment in at least one end region with an extent of at least one of said insertion surface and said shaft insertion surface.

13. The foil bearing of claim 1 further comprising an axially protruding locking element arranged on an end face of said bearing bushing.

14. A rotor-stator arrangement or bearing arrangement comprising:
a foil bearing;
a shaft arranged in said foil bearing such that said shaft is rotatable about a longitudinal axis;
said foil bearing including a bearing bushing having a central recess;
said central recess having a bearing surface for mounting said shaft such that said shaft is rotatable about the longitudinal axis;
at least one bearing foil arranged in said central recess and is adapted to form a gap between said at least bearing foil and a running surface of said shaft; and,
wherein at least one of:
said bearing bushing having on at least one side, in a region of said central recess, an insertion surface extending obliquely with respect to the longitudinal axis, and,
said shaft having a shaft portion arranged within said bearing bushing which has a shaft insertion surface that extends obliquely with respect to the longitudinal axis.

15. The bearing arrangement of claim 14, wherein at least one of said insertion surface and said shaft insertion surface is formed at least at one of: on both sides of said bearing bushing, and along two shaft portions of the shaft that are arranged at a mutual distance.

16. The bearing arrangement of claim 14, wherein at least one of said insertion surface and said shaft insertion surface is configured as a circumferential chamfer and extends between an end face of said bearing bushing or shaft and said bearing surface on said bearing bushing or the running surface on the shaft.

17. The bearing arrangement of claim 14, wherein at least one of said insertion surface and said shaft insertion surface, based on the longitudinal axis of said bearing bushing or shaft, extends obliquely at an angle α of less than 45°.

18. The bearing arrangement of claim 14, wherein at least one of said insertion surface and said shaft insertion surface is convexly curved.

19. The bearing arrangement of claim 14, wherein said at least one bearing foil has a width dimension corresponding to a width of said bearing surface of said bearing bushing.

20. The bearing arrangement of claim 14, wherein said at least one bearing foil has a width dimension that is shortened compared to a width of said bearing surface of said bearing bushing.

21. The bearing arrangement of claim 14, wherein said at least one bearing foil is shortened relative to said bearing surface, at least at one face of said bearing bushing, such that a side edge defining a width dimension of said at least one bearing foil is in alignment with an oblique extent of said insertion surface.

22. The bearing arrangement of claim 14, wherein a plurality of bearing foils are arranged one above an other in said gap between said bearing surface of said bearing bushing and said running surface of said shaft.

23. The bearing arrangement of claim 22, wherein said plurality of bearing foils includes an inner bearing foil arranged on an inside and an outer bearing foil arranged on an outside; and, said inner bearing foil has an internal width dimension that is shortened compared to an external width dimension of said outer bearing foil.

24. The foil bearing of claim 23, wherein said inner bearing foil and said outer bearing foil each have side edges that are in alignment in at least one end region with an extent of at least one of said insertion surface and said shaft insertion surface.

25. The bearing arrangement of claim 14 further comprising an axially protruding locking element arranged on an end face of said bearing bushing.
